(19) United States
(12) Patent Application Publication
(10) Pub. No.: US 2024/0073195 A1
(43) Pub. Date: Feb. 29, 2024

(54) ON THE FLY CERTIFICATE GENERATION

(71) Applicant: UAB 360 IT, Vilnius (LT)

(72) Inventors: Juta Gurinaviciute, Vilnius (LT); Carlos Eliseo Salas Lumbreras, Vilnius (LT)

(21) Appl. No.: 17/893,544

(22) Filed: Aug. 23, 2022

(51) Int. Cl. H04L 9/40

(52) U.S. Cl. CPC H04L 63/0823; H04L 63/0263; H04L 63/0272

(57) ABSTRACT

Certificate generation is provided by the rule set of an AI-powered extension used to categorize the domains and restrict access to the specific categories of websites. As a result, a user may receive a return “blocked” error page with a valid certificate. If the domain falls under a category of rules, in response to a user's DNS query, the domain name is extracted from the header of the query; a certificate is generated based on the domain's name; a “Blocked” error page (with a valid certificate) using a route certificate is returned. Thus, a valid error page informs the client why the website cannot be reached, in which category/-ies it has been included, and what level of threat this page has.

### BACKGROUND

### Field

Embodiments of the present invention relate to generation of a certificate, specifically a certificate that generates a custom certificate on demand.

### Background

Digital certificates are a method of user or website authentication to prove that a device (user computer or website server) is the device it claims to be. When a certificate authority (CA) issues a certificate to a device, such as a website server, the CA is guaranteeing that the website originates from the device from which it claims to originate, thereby assuring a user of the security or authenticity of the website it is accessing.

The certificate presented and the certificate authority that issued the certificate must be trusted by the peer device. If a remote party does not recognize or trust the certificate authority, then the identity will not be trusted. Certificates issued by a known provider may be trusted in most instances, but certificates issued by lesser-known certificate authorities may not be trusted by a particular gateway device. In reality, the server or connection may be secure, and the certificate or certificate authority is simply unrecognized. There may be a simple fix, for example, manually trusting the certificate authority by importing its certificate into the device. However, such manual bypass may expose the user's device to malicious circumstances or diverge from a business's objectives.

When a user is blocked access to a domain, standard or “canned” error messages are often provided to the user, but no or little information about the true reason for the denial, such as a business reason, a certificate that was not trusted may not be conveyed. Examples of such an error message are shown in FIG. 1. That is, in the current state of the art, the page error certificates provided in return to the user's request to reach the URL do not introduce all the information about the reason for blocking access. In some circumstances, user s may be allowed to bypass the notice that the server, connection, or communication channel is not trusted and proceed to the website anyway, in spite of a business's reasons for not wishing a user to proceed.

Thus, there may be a problem in the field of understanding the follow-up action by a company employee and requires extra redundant communication with an administrator, since a user can be unaware if a website is malicious or included into the list of unwanted categories, or the website is currently under the DDoS attack, or the website is a proxy, etc.

### BRIEF SUMMARY OF THE DISCLOSURE

Accordingly, the present invention is directed to “on the fly” certificate that obviates one or more of the problems due to limitations and disadvantages of the related art.

In accordance with the purpose(s) of this invention, as embodied and broadly described herein, this invention, in one aspect, relates to a method for generating a custom error message in response to a DNS query. The method receiving by a computing device a request for access to a domain; checking identification information for the requested domain against a set of rules establishing whether access to the requested domain is permitted; and upon determination that access to the requested domain is not permitted according to the set of rules, extracting a domain name from the request and returning a blocked error message for the domain expressing a reason why the access to requested was not permitted according to the set of rules and a certificate for the domain.

In another aspect, the invention relates to a system for generating a custom error message in response to a DNS query. The system comprises at least one processor and a computer readable medium storing thereon computer executable instructions that cause the system to receive a request for access to a domain; check identification information for the requested domain against a set of rules establishing whether access to the requested domain is permitted; upon determination that access to the requested domain is not permitted according to the set of rules, extract a domain name from the request and return a blocked error message for the domain expressing a reason why the access to requested was not permitted according to the set of rules and a certificate for the domain.

In yet another aspect, the invention relates to a non-transitory computer readable medium storing computer executable instructions stored thereon that when executed by at least one processor cause the at least one processor to receive a request for access to a domain; check identification information for the requested domain against a set of rules establishing whether access to the requested domain is permitted; upon determination that access to the requested domain is not permitted according to the set of rules, extract a domain name from the request and return a blocked error message for the domain expressing a reason why the access to requested was not permitted according to the set of rules and a certificate for the domain.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate “on the fly” certificate generation. Together with the description, the figures further serve to explain the principles of the on the fly” certificate generation described herein and thereby enable a person skilled in the pertinent art to make and use the on the fly” certificate generation.

FIG. 1 illustrates examples of conventional error messages for an untrusted certificate.

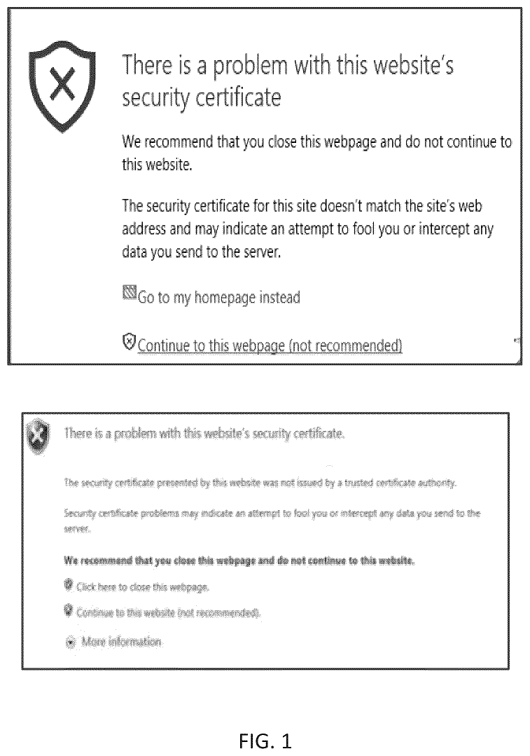

FIG. 2 illustrates response policy zone creation and custom zoning for certificate generation.

FIG. 3 illustrates certificate generation according to principles described herein.

FIG. 4 illustrates a certificate generated according to principles described herein.

FIG. 5 illustrates an exemplary embodiment according to principles described herein.

FIG. 6 illustrates an exemplary system for implementing aspects described herein includes a computing device, such as computing device.

### DETAILED DESCRIPTION

Reference will now be made in detail to embodiments of the on the fly” certificate generation with reference to the accompanying figures. The same reference numbers in different drawings may identify the same or similar elements.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

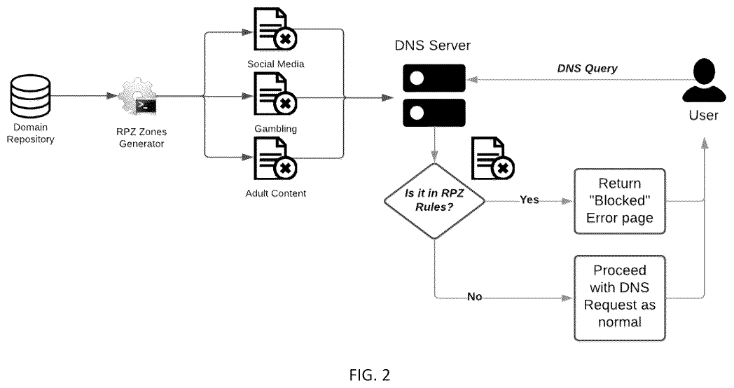

A DNS query 114 (also known as a DNS request) is a demand for information sent from a user's computer 106 (DNS client) to a DNS server 102, as shown in FIG. 2. In most cases a DNS query 114 is sent to ask for an IP address associated with a domain name. As illustrated in FIG. 2, a DNS Server 102 sits between a user 106 and a domain repository 110. The DNS server 102 may be any appropriate computer server that provides an IP address in response to a DNS query 114 from the user based, for example, on a uniform resource locator (url) or website to which the user seeks access through a network, such as the internet. For example, the DNS repository 110 may contain a database of public IP addresses and their associated hostnames, and in most cases serves to resolve, or translate, those names to IP addresses as requested by the user. DNS servers may run standard or special software and communicate with each other using special protocols.

According to principles described herein, the DNS server 102 translates the DNS query 114 to determine to which webpage or domain 124 the user 106 is seeking access. The DNS server also accesses a set of rules via, for example, a response policy zone (RPZ) rules set 116, to determine if the user has an authorized access to the domain he seeks. An error message or access to the requested domain can then proceed according to the RPZ 116 via the DNS server 102.

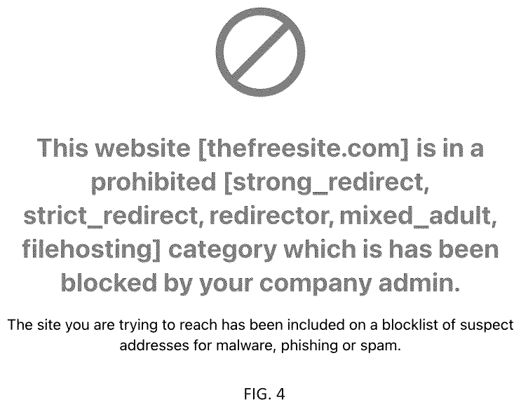

Moreover, an error message provided to the user may be customized in view of the RPZ based on a customized policy for blocking certain domains performed by AI-powered (learning) categorization of domains for access control, thus providing users with valid error page certificates. Thus, informing a user why the access to a domain is denied may be provided using the RPZ rules set by an artificial intelligence (AI) tool set to follow by the DNS server. For example, “instant certificate generation” may result from RPZ rules of an AI-powered extension used to categorize the domains and restrict access to the specific categories of websites. As a result, a user may receive a return “blocked” error page with a valid certificate, as illustrated in FIG. 4. In other words, instead of the user being unable to reach any error page, it is possible to display on a web browser a web page that provides information to the user.

In some circumstances, usage of an RPZ is based on DNS data feeds, known as zone transfer, from an RPZ provider to the deploying server. Web browsers, and any other client applications which connect to servers on the Internet, need the IP address of the server in order to open the connection. The local resolver is usually a system software which in turn puts the query to a recursive resolver, which often is located at the Internet service provider. If the latter server deploys RPZ, and either the queried name or the resulting address are in the blocklist, the response is modified so as to impede access. As shown in FIG. 2, DNS Server may access an RPZ rules query 116 to determine if the domain name requested or other identifying feature for the domain is one to which the user has an authorized access.

For example, as illustrated in FIG. 2, the response could be simple a “No” for one to which the user is authorized access or a “Yes” for a domain that is blocked to the user. In the event of a “no”, the DNS request proceeds as normal and the user is given access to the requested domain 120. A blocked domain per the RPZ rules query may result in returning a “blocked” error page 122 being displayed to the user 106.

Referring again to FIG. 2, an RPZ zone generator 118 may be between the domain repository 110 and the DNS server 102. The RPZ zone generator 118 may be customizable to adapt the RPZ rules. For each zone, the DNS service may choose to perform full resolution (normal behavior), or other actions, including declaring that the requested domain does not exist (technically, NXDOMAIN), or that the user should visit a different domain (technically, CNAME), amongst other potential actions. As zone information can be obtained from external sources (via a zone transfer) this allows a DNS server 102 to obtain information from an external organization about domain information and then choose to handle that information in a non-standard manner.

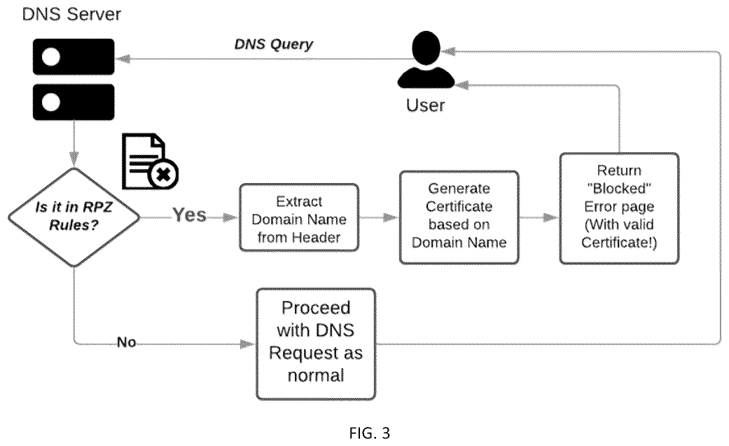

Referring to FIG. 3, according to principles described herein, if the domain requested falls under a category of RPZ rules 316, in response to a user's DNS query 314, in order to customize the certificate, a processor, processing system, computer, or computing system (the “system”) may extract the domain name at block 326. Then, at block 328, the system may generate a certificate based on the extracted Domain name and, at block 330, issue “Blocked” Error page (with a valid Certificate) using a root certificate is returned. The blocked error message may provide with it a reason that access to the domain was blocked. The message may further include a level of threat posed by the domain. Accordingly, a valid error page informs the client why the website cannot be reached, in which category/-ies it has been included, and what level of threat this page has. The generated certificate may be formatted to look like it originated from the desired webpage.

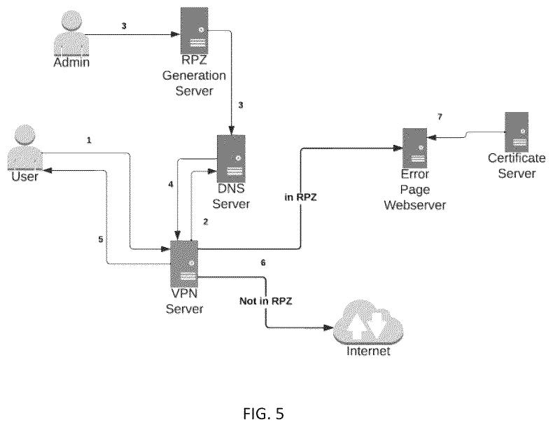

The system and methods described herein may be supported by a VPN (virtual private network) application running on the user device and that routes the user device's internet connection through a VPN server before interaction with a public network, such as DNS Server or the Internet. In an exemplary embodiment, as illustrated in FIG. 5, according to principles described herein, a user connects to a VPN provider (1). A DNS request is made from the user's side and sent into the DNS server (2). Prior to the request being processed, an RPZ will be generated according to the user's admin-given parameters (3). A DNS response is generated according to the given parameters (4). The location of the resource that the user wants to reach is given back to the user's device (5). Depending on if the user's request was in the RPZ or not, it will be directed either to the internet or to an error page as described herein (6). In case the user is directed to the error page, a certificate will be generated for that specific domain according to principles described herein (7). For example, a certificate generation server may act as the certificate authority. The error page is rendered by the VPN provider. Accordingly, access to the requested domain is through the VPN Layer and encrypted tunnel. This configuration allows an administrator to select and block certain features. It is easier for an administrator to block access to a DNS server than to monitor it throughout.

While described here as a VPN, which provides internet access and an encrypted tunnel, any server, private or public, may perform the functions described herein or the functionality may be provided by a cloud actor, such as a software as a service (SaaS) provider. In other words, in an aspect of designs according to principles described herein, the VPN server/infrastructure may be an adjacent system that runs alongside this system and method described herein.

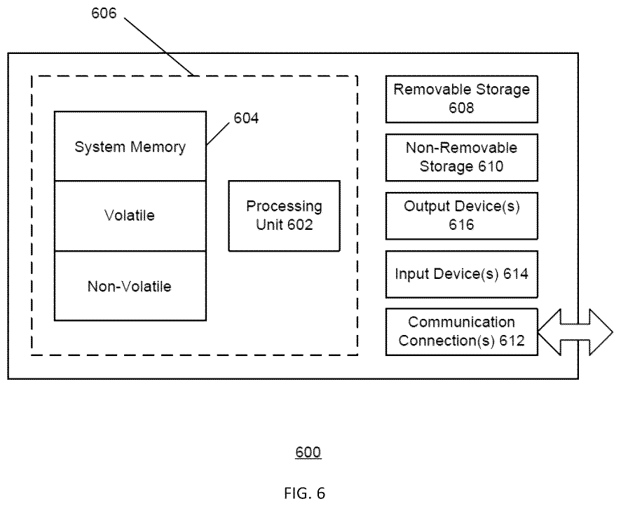

Many organizations categorize domains. These categorized domains may be used for a variety of purposes such as search engine creation and access control. Such categorization may be AI-driven, such as described in U.S. patent application Ser. No. 17/845,249, filed Jun. 21, 2022, pending, which is hereby incorporated by reference for all purposes as if fully set forth herein. The proposed system for certificate generation can leverage categories of web pages or classifications for powering the rules set applied for allowing or denying access to certain categories of websites by the user device. The system may further be dynamic, whereby the rules set may be automatically updated according to the classifications/categories or manually updated. With reference to FIG. 6, an exemplary system for implementing aspects described herein includes a computing device, such as computing device 600. In its most basic configuration, computing device 500 typically includes at least one processing unit 602 and memory 654. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents.

What is claimed is:

1. A method for generating a custom error message in response to a DNS query, the method comprising:
receiving by a computing device a request for access to a domain;
checking identification information for the requested domain against a set of rules establishing whether access to the requested domain is permitted; and
upon determination that access to the requested domain is not permitted according to the set of rules, extracting a domain name from the request and returning to a computer device a blocked error message for the domain expressing a reason why the access to the requested domain was not permitted according to the set of rules and a certificate for the domain.

2. The method of claim 1, further comprising, upon determination that access to the requested domain is not permitted according to the set of rules, generating a certificate with the extracted domain name, wherein the blocked error message comprises the certificate.

3. The method of claim 2, wherein the set of rules is a response policy zone (RPZ).

4. The method of claim 3, wherein the RPZ is generated according to parameters given by a user's administrator.

5. The method of claim 4, wherein the determination is based on the parameters given by the user's administrator.

6. The method of claim 1, wherein the computing device is a virtual private network server.

7. The method of claim 6, wherein the virtual private message server is a proxy for a DNS server.

8. A system for generating a custom error message in response to a DNS query, comprising:
at least one processor; and
a computer-readable medium storing computer executable instructions stored therefore that when executed by the at least one processor cause the system to:
receive a request for access to a domain;
check identification information for the requested domain against a set of rules establishing whether access to the requested domain is permitted;
upon determination that access to the requested domain is not permitted according to the set of rules, extract a domain name from the request and return to a computer device a blocked error message for the domain expressing a reason why the access to the requested domain was not permitted according to the set of rules and a certificate for the domain.

9. The system of claim 8, further comprising, upon determination that access to the requested domain is not permitted according to the set of rules, generating a certificate with the extracted domain name, wherein the blocked error message comprises the certificate.

10. The system of claim 9, wherein the set of rules is a response policy zone (RPZ).

11. The system of claim 10, wherein the RPZ is generated according to parameters given by a user's administrator.

12. The system of claim 11, wherein the determination is based on the parameters given by the user's administrator.

13. The system of claim 8, wherein the processor is a virtual private network server.

14. The system of claim 13, wherein the virtual private message server is a proxy for a DNS server.

15. A non-transitory computer-readable medium storing computer executable instructions stored thereon that when executed by at least one processor cause the at least one processor to:
receive a request for access to a domain;
check identification information for the requested domain against a set of rules establishing whether access to the requested domain is permitted;
upon determination that access to the requested domain is not permitted according to the set of rules, extract a domain name from the request and return to a computer device a blocked error message for the domain expressing a reason why the access to the requested domain was not permitted according to the set of rules and a certificate for the domain.

16. The non-transitory computer-readable medium of claim 15, further comprising, upon determination that access to the requested domain is not permitted according to the set of rules, generating a certificate with the extracted domain name, wherein the blocked error message comprises the certificate.

17. The non-transitory computer-readable medium of claim 16, wherein the set of rules is a response policy zone (RPZ).

18. The non-transitory computer-readable medium of claim 17, wherein the RPZ is generated according to parameters given by a user's administrator.

19. The non-transitory computer-readable medium of claim 15, wherein the processor is a virtual private network server.

20. The non-transitory computer-readable medium of claim 19, wherein the virtual private message server is a proxy for a DNS server.
